(19) United States
(12) Patent Application Publication
(10) Pub. No.: US 2006/0134253 A1
(43) Pub. Date: Jun. 22, 2006

(54) Injection unit with a rotating valve for processing meltable materials

(76) Inventors: Gerhard Edler, Trebur (DE); Hans-Joachim Keim, Stuttgart (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/546,563

(22) PCT Filed: Jan. 28, 2004
(86) PCT No.: PCT/EP04/00718

§ 371 Date: Aug. 19, 2005

(30) Foreign Application Priority Data
Feb. 22, 2003 (DE) 103 07 616.6

(51) Int. Cl. B29C 35/08

(52) U.S. Cl. 425/155; 425/562

(57) ABSTRACT

The invention is based on an injection unit for the processing of fusible materials, for example thermoplastics, ceramic or metallic compositions or the like, in which at least two melt streams are fed via a channel system to one or more mould cavities in a sequence which changes with time.

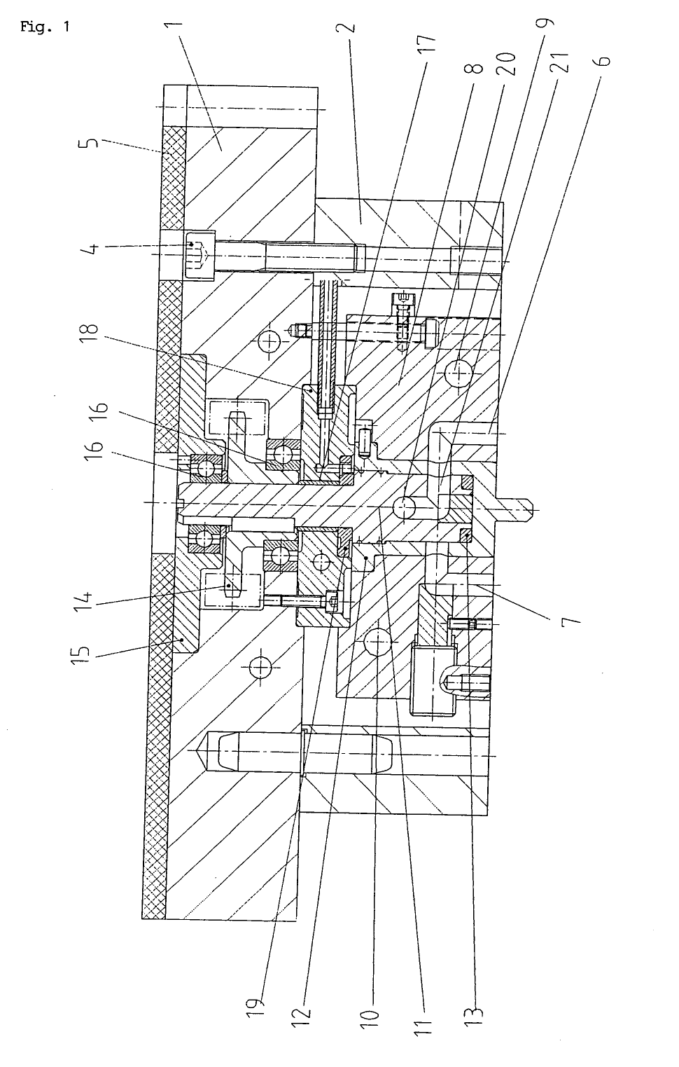

In accordance with the invention, only one rotating valve element is provided for each channel system which leads to the mould cavity (cavities) and consists of at least two feed channels (6; 7). The valve element consists of a hollow spindle (11), which is connected to the pressure channel (20) of the melt and has, in the plane of the feed channels (6; 7) leading to the mould cavity (cavities), at least one distribution channel (21) which runs radially outwards and is likewise connected to the pressure channel (20).

### PRIOR ART

The invention is based on an injection unit for plants for the processing of fusible materials, for example thermoplastics, ceramic or metallic compositions or the like, as defined in the main claim. Processing plants of this type are known, for example, as injection-moulding or alternatively extrusion plants for the area of plastics processing plants and as injection-moulding plants for ceramic and metallic compositions. In this principle of moulding production, mould cavities formed correspondingly to the mouldings to be produced are filled with melt. The injection unit here is part of the hot channel, through which the melt is conveyed at low or high pressure at the processing temperature necessary for the particular substance, and enters the mould cavity via nozzles. In order to ensure high product quality, i.e. both adequate strength throughout the moulding and optical uniformity, it is necessary to achieve intimate mixing of the melt streams at the flow lines, i.e. the points in the moulding where the previously separate melt streams meet one another again. To this end, it is already known to set the individual melt strands in vibration or pulsation, at least in sections, causing the melts to penetrate through in the region of the flow lines owing to the vibration differences and the flow lines to undergo intensive bonding to one another at the joint of the melt strands (DE 100 52 841 A1). This publication also describes a plastics processing plant with a plastics injection-moulding machine, an injection-moulding tool having a cavity for the injection mould and at least two injection valves, each with a control mechanism, for corresponding injection nozzles opening into the cavity. The valves can be opened or closed by the control mechanism, independently of the injection pressure, with the control mechanism of the individual valves being synchronised with one another. The simplest form of valve is a valve needle having an inclined groove arranged on its outer surface. However, the use, likewise described, of rotary slides with roller bearings and T-shaped control channels is more favourable from a functional point of view. The disadvantage of these solutions consists in the relatively high complexity required by this injection unit. After all, pressures of up to 3000 bar prevail in the injection unit. The rotating valve needles or rotary slides must be sealed off from the casing, which in turn makes the injection unit more expensive. In addition, there is the complexity for synchronisation, which in all cases requires a gearbox. Also disadvantageous is the space requirement for this design. The spatial capacity in the hot channel is limited. Finally, mention should be made of the complexity for thermal insulation, which in each case has to be operated for two rotating parts.

### THE INVENTION AND ITS ADVANTAGES

The injection unit according to the invention with the characterising features of the main claim reduces the complexity for sealing, thermal insulation and drive on a channel system supplying only one rotating component per mould cavity. In addition, synchronisation of the rotation of two valve needles or rotary slides which supply the same mould cavity with melt is unnecessary. This has been achieved by a design in which the melt enters a rotating hollow spindle directly and passes from this through at least one distribution channel which runs radially outwards, to the nozzles opening into the mould cavity. This means that only one rotating valve element, i.e. a hollow spindle, is provided for each of the associated melt strands, i.e. for the melt strands which form a channel system and are combined again in one and the same mould cavity. The hollow spindle thus has two jobs, namely transportation of the melt flow to at least two channels, and interruption of the melt flow in order to generate the pulsation. It is of course also conceivable for a plurality of channel systems to be supplied by one hollow spindle. It is unimportant here whether the channel systems supply one or more mould cavities with melt.

According to an advantageous embodiment of the invention, the hollow spindle has two distribution channels which run radially outwards and are not arranged at the same angle to one another as the feed channels intended to supply them with melt. If, for example, the two channels are located precisely opposite one another, the angle between the two distribution channels must not be 180° in order that the filling of the two channels takes place successively in terms of time. The arrangement of more than one distribution channel has the advantage that the pulsation frequently can be increased without changing the rotational speed of the hollow spindle.

According to a further advantageous embodiment of the invention, the distribution channels are arranged at levels of the hollow spindle which lie one above the other, even if the channels are arranged one on top of the other.

Further advantages and advantageous embodiments of the invention are revealed by the following example description, the drawing and the claims.

### DRAWING

An illustrative embodiment of the invention is shown in the drawing and is described in greater detail below. The figure shows a cross section through an injection unit in the reverse installation position, which serves on the nozzle side as platen for an injection-moulding machine. It consists of a platen 1 and an intermediate plate 2, which are firmly connected to one another by means of guide columns 3 and cap screws 4. The injection unit is thermally insulated from the adjacent parts of the injection-moulding machine by means of an insulation plate 5. In the present depiction, the mould cavity (not depicted in greater detail), into which two feed channels 6 and 7 open, follows below the intermediate plate 2. A heating block 8, which is held at the melting point by heating cartridges 9 and 10, is located in the interior of the intermediate plate 2. The central constituent of the injection unit is a hollow spindle 11, which is guided in the heating block 8 by means of a wear sleeve 12 and a bearing ring 13. In the region of the platen 1, a chain wheel 14 is connected in a rotationally fixed manner to the hollow spindle 11 via a tongue-and-groove joint. The bearing of hollow spindle 11 and chain wheel 14 in the platen 1 takes place by means of a bearing plate 15 and groove ball bearings 16. The hollow spindle 11 has an additional guide in the transition region from the platen 1 to the intermediate plate 2 through a guide sleeve 17, a support ring 18 and a wear ring 19. The cavity of the hollow spindle 11 is connected to the pressure channel of the injection-moulding machine so that the melt enters the latter. In the present sectional depiction, this is indicated by the pressure channel 20, which, after a short axial guide, becomes a radial distribution channel 21.

The mode of action of the invention will be described in greater detail below. The chain wheel 14 and thus also the hollow spindle 11 is, in the present example, driven by means of a chain (not shown) of a gear motor (likewise not shown). The distribution channel 21 of the hollow spindle 11 thus alternately connects the two feed channels 6 and 7 to the pressure channel 20, so that the melt stream, divided into two partial melt streams, enters the mould cavity in a pulsed manner. The hollow spindle 11 accordingly has a double function, namely that of distribution of the melt over at least two feed channels and generation of the pulsation. In the present example, the hollow spindle 11 has only one radial distribution channel 21, i.e. during a rotation of the hollow spindle 11, each of the feed channels 6 and 7 is also only connected to the pressure channel 20 once. The pulsation frequency of a feed channel 6; 7 accordingly corresponds to the rotational speed of the hollow spindle 11, with the pressure pulses in each case being phase-shifted by 180°. If more than one distribution channel 21 is provided in a plane, these must always be at a different angle to one another than the feed channels 6; 7 located in this plane, i.e. it must be ensured that, whenever a feed channel 6; 7 is just connected to the pressure channel 20, the other is closed by the envelope of the hollow spindle 11.

All features represented in the description, the following claims and the drawing can be essential to the invention, both individually and in any desired combination with one another.

List of Reference Numerals

1 platen
2 intermediate plate
3 guide columns
4 cap screws
5 insulation plate
6 feed channel
7 feed channel
8 heating block
9 heating cartridge
10 heating cartridge
11 hollow spindle
12 wear sleeve
13 bearing ring
14 chain wheel
15 bearing plate
16 groove ball bearings
17 guide sleeve
18 support ring
19 wear ring
20 pressure channel
21 distribution channel

1. Injection unit for the processing of fusible materials, in which at least two melt streams are fed to one or more mould cavities via a channel system in a sequence which changes with time, with the change in time of the feed of the melt streams taking place through temporary opening and closing of the feed channels (6; 7) leading to the mould cavity (cavities), and, as means for temporary opening and closing of rotating valve elements, the feed channels (6; 7) connect to the pressure channel (20) of the melt alternately one after the other, characterised in that only one valve element is provided for each channel system which leads to the mould cavity (cavities) and consists of at least two feed channels (6; 7), and the valve element consists of a hollow spindle (11), which is connected to the pressure channel (20) of the melt and has, in the plane of the feed channels (6; 7) leading to the mould cavity (cavities), at least one distribution channel (21) which runs radially outwards and is likewise connected to the pressure channel (20).

2. Injection unit according to claim 1, characterised in that the hollow spindle (11) has two distribution channels (21) which run radially outwards and are not arranged at the same angle to one another as the feed channels (6; 7) intended to supply them with melt.

3. Injection unit according to claim 2, characterised in that the distribution channels (21) running radially outwards are in different planes in the hollow spindle (11).
